(19) United States
(12) Patent Application Publication
(10) Pub. No.: US 2003/0160763 A1
(43) Pub. Date: Aug. 28, 2003

(54) Mouse with water-proof and impact-proof structure

(76) Inventors: Li-Der Cheng, Taipei (TW); Yi-Jung Lee, Keelung (TW)

Correspondence Address: BROWDY AND NEIMARK, P.L.L.C., Suite 300, 624 Ninth, N.W., Washington, DC, 20001, US

(21) Appl. No.: 10/082,195

(22) Filed: Feb. 26, 2002

(51) Int. Cl. G09G 5/08

(52) U.S. Cl. 345/163

(57) ABSTRACT

A mouse assembly includes a base having an open top for a frame received in the open top of the base. The frame has a protrusion in which a trace sphere is rotatably engaged A reflection board is received in the protrusion and located below the trace sphere. A circuit board with a limit switch is connected to an underside of the frame and located below the reflection board The limited is activated by hitting the under board of the base when pushing the trace sphere. A flexible water-proof plate is mounted to a top of the flame and has an aperture with which the trace sphere is engaged. The frame has legs and each leg has a spring which is biased between the leg and under board

### FIELD OF THE INVENTION

The present invention relates to a mouse assembly including a frame movably received in a base and flexible water-proof plate is engaged with the trace sphere so that water or liquid cannot enter in the base.

### BACKGROUND OF THE INVENTION

A conventional mouse for public use such as used with public telephone generally includes frictional type and optical type. Either one of the two types is usually embedded in a base which is fixed on a board. It is possible that the user brings a cup of drink which is put beside the mouse and the drink could be splashed out and enters the base. The circuit of the electronic equipment of the base and the mouse is short when the drink reaches the circuit board. In addition, the trace sphere could be hit by the users and the electronic parts could be damaged.

### SUMMARY OF THE INVENTION

In accordance with one aspect of the present invention, there is provided a mouse assembly which comprises a base and a frame is movably received in the open top of the base. The frame has a protrusion which has a passage defined therethrough so that a trace sphere is rotatably engaged with passage of the frame.

A reflection board is received in the protrusion and located below the trace sphere. A circuit board is connected to an underside of the frame and located below the reflection board.

A flexible water-proof plate is mounted to a top of the frame and has an aperture with which the trace sphere is engaged.

The primary object of the present invention is to provide a mouse assembly which has a flexible water-proof plate enclosing the trace sphere so as to prevent liquid from entering the interior of the mouse assembly.

Another object of the present invention is to provide a mouse assembly wherein the frame with the trace sphere connected thereto has springs biased between the surface on which the mouse assembly is put and the frame.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a mouse assembly of the present invention;

FIG. 2 is a cross sectional view to show mouse assembly of the present invention;

FIG. 3 is a bottom view to show the reflection board connected to the frame of the mouse assembly of the present invention, and

FIG. 4 is a side view to show a limit switch on the circuit board is located lower than the legs of the frame of the mouse assembly of the present invention.

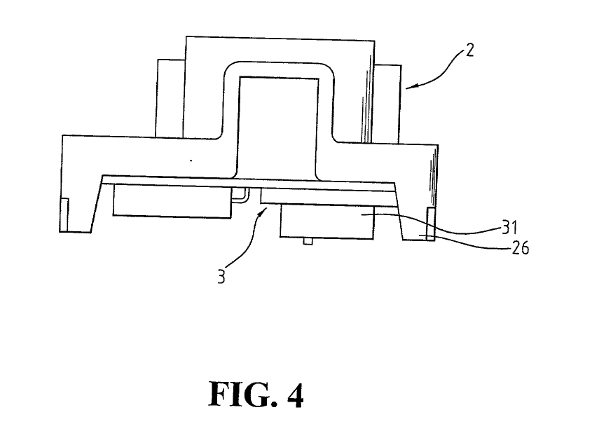

### DETAILED DESCRIPTION OF THE INVENTION

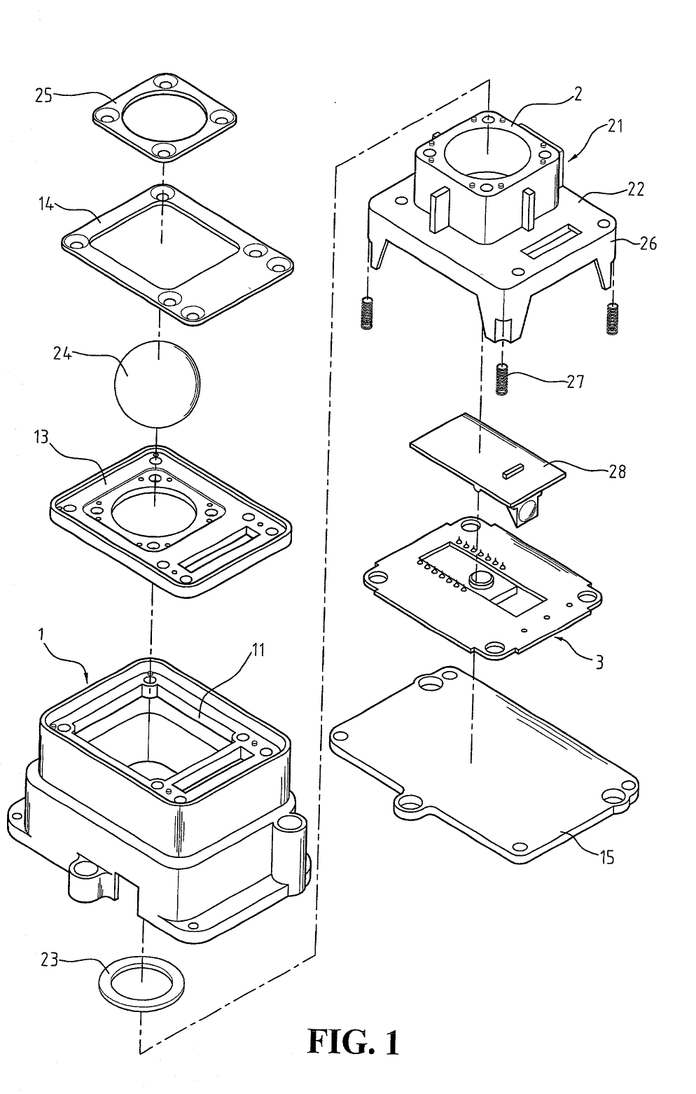

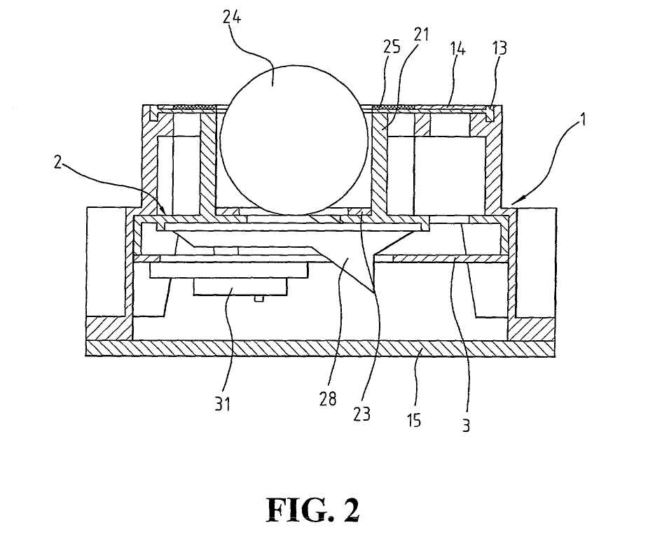

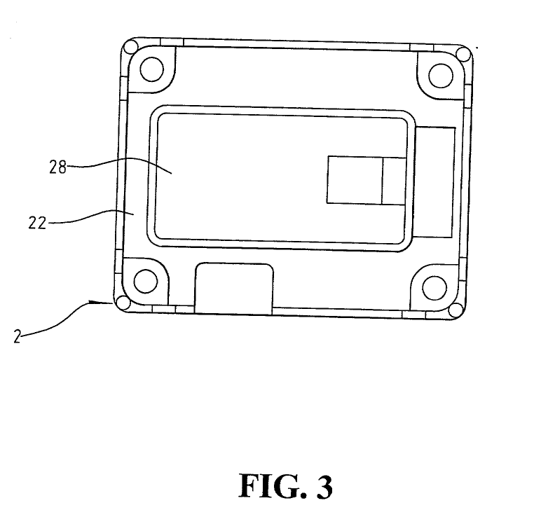

Referring to FIGS. 1 to 3, the mouse assembly of the present invention comprises a base 1 having an open top 11 and an under board 15 is connected to an underside of the base 1. A frame 2 is received in the open top 11 of the base 1 and has a protrusion 21 from a top surface 22 of the frame 2. The protrusion 21 has a passage defined therethrough and four legs 26 extend from the frame 2. Each leg 26 has a spring 27 connected thereto and the springs 27 are biased between the legs 26 and the under board 15.

A flexible water-proof plate 13 is mounted to a top of the protrusion 21 of the frame 2 and has an aperture with which the trace sphere 24 is engaged. A cover plate 14 is engaged with the top of the protrusion 21 and presses the flexible water-proof plate 13 in position. A protection plate 25 is connected to the cover plate 14 and is engaged with the aperture of the flexible water-proof plate 13 so as to retain an upper portion of the trace sphere 24 from being disengaged from the flexible water-proof plate 13. A retaining collar 23 is received in the passage of the protrusion 21 and a lower portion of the trace sphere 24 is engaged with the collar 23.

A reflection board 28 is received in the protrusion 21 and located below the trace sphere 24. A circuit board 3 is connected to an underside of the frame 2 and located below the reflection board 28. The circuit board 3 includes electronic parts and a limit switch 31 connected to an underside of the circuit board 3. The electronic parts and the limit switch 31 face the under board 15.

The position mark on the screen can be controlled by rotating the trace sphere 24 and the water-proof plate ensures that no liquid or particles will enter into the passage of the protrusion 21. When the trace sphere 24 is pushed, because the length of the legs 26 are shorter than the distance from the circuit board 3 to the limit switch 31, so that when the trace sphere 24 is pressed by the users, the limit switch 31 touches the under board 15 and the computer is received an “Enter” signal.

The springs 27 absorb the shocks that could be applied to the whole assembly and the water-proof plate 13 protects the circuit board 3 from being countered with liquid or other particles from outside of the mouse assembly.

While we have shown and described the embodiment in accordance with present invention, it should be clear to those skilled in the art that further embodiments may be made without departing from the scope of the present invention.

What is claimed is:

1. A mouse assembly comprising:
a base having an open top;
a frame received in the open top of the base, the frame having a protrusion which has a passage defined therethrough;
a trace sphere rotatably engaged with passage of the frame and a reflection board received in the protrusion and located below the the sphere, a circuit board connected to an underside of the frame and located below the reflecton board electronic and a limit switch conected to an underside of the circuit boad, the limit switch adapted to face a surface on which the base is put and
a flexible water-proof plate mounted to a top of the protrusion of the frame and having an aperture with which the trace sphere is engaged.

2. The mouse assembly as claimed in claim 1, wherein the frame has a plurality of legs and each leg having a spring connected thereto, an under board connected to an underside of the base and the springs biased between the legs and the under board.

3. The mouse assembly as claimed in claim 1, further comprising a retaining collar received in the passage in the protrusion and a lower portion of the trace sphere being engaged with the collar.

4. The mouse assembly as claimed in claim 1, furher comprising a protection plate engaged with the aperture ofthe flexible water-proof plate so as to retain an upper portion of the trace sphere.

5. The mouse assembly as claimed in claim 1, wherein a length of each of the legs is shorter than a distance from the circuit board to the limit switch.
